(19) United States
(12) Patent Application Publication
(10) Pub. No.: US 2022/0341520 A1
(43) Pub. Date: Oct. 27, 2022

(54) WIDE RANGE PIPE FITTING

(71) Applicant: Mueller International, LLC, Atlanta, GA (US)

(72) Inventor: Ryan Fairchild Larson, Decatur, IL (US)

(21) Appl. No.: 17/236,365

(22) Filed: Apr. 21, 2021

(51) Int. Cl. F16L 17/04; F16B 39/24

(52) U.S. Cl. CPC F16L 17/04; F16B 39/24

(57) ABSTRACT

A joint assembly can include a piping element and a fastener configured to secure a pipe length to the piping element, the fastener including: a nut; a gasket positioned at least partially between the nut and the piping element; and a grip band positioned at least partially between the nut and the gasket, the grip band defining a first axial end and a second axial end, the grip band including a plurality of teeth extending from the first axial end, each of the plurality of teeth configured to rotate with respect to an axis of the grip band in transition between an uncompressed condition and a compressed condition to change a corresponding angle of attack of each of the plurality of teeth with respect to the pipe length.

### TECHNICAL FIELD

### Field of Use

This disclosure relates to pipe joint assemblies. More specifically, this disclosure relates to pipe joint assemblies in which a grip band with teeth is configured to rotate into engagement with a length of pipe forming a part of the joint assembly.

### Related Art

Components in a fluid distribution system can be joined to each other with fasteners to facilitate any one or more of manufacturability, shipping, installation, and service of the system or just a portion thereof. A typical connection can sometimes require significant torque to fully tighten and a pipe can pull out of the connection if the connection is not tightened enough. Sometimes, however, it can be difficult to apply the necessary torque when the joint assembly is buried underground or otherwise difficult to access even when exposed. Moreover, it can be difficult to know what type of pipe fitting will seal and restrain the discovered pipe, which can be of unknown diameter. Even if an inner diameter of a pipe is consistent throughout a distribution system, an outer diameter of the pipe can vary based on the material, examples of which may no longer be manufactured even if still in service.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a joint assembly comprising: a piping element; and a fastener configured to secure a pipe length to the piping element, the fastener comprising: a nut; a gasket positioned at least partially between the nut and the piping element; and a grip band positioned at least partially between the nut and the gasket, the grip band defining a first axial end and a second axial end, the grip band comprising a plurality of teeth extending from the first axial end, each of the plurality of teeth configured to rotate with respect to an axis of the grip band in transition between an uncompressed condition and a compressed condition to change a corresponding angle of attack of each of the plurality of teeth with respect to the pipe length.

In a further aspect, disclosed is a method of using a joint assembly, the method comprising: engaging a fastener with a piping element, the fastener comprising: a nut; a gasket positioned at least partially between the nut and the piping element; and a grip band positioned at least partially between the nut and the gasket, the grip band comprising a plurality of teeth; inserting a pipe length through the fastener and into the piping element; and tightening the fastener against the piping element, which comprises: reducing an inner diameter of the grip band while maintaining an outer diameter of the grip band; and engaging the grip band with the pipe length to fix a position of the pipe length with respect to a position of each of the fastener and the piping element.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and together with the description, serve to explain various principles of the disclosure. The drawings are not necessarily drawn to scale. Corresponding features and components throughout the figures may be designated by matching reference characters for the sake of consistency and clarity.

FIG. 1 is an exploded perspective view of a joint assembly comprising a piping element, a pipe length, and a fastener in accordance with one aspect of the current disclosure.

FIG. 2A is a sectional view of a piping element of the joint assembly of FIG. 1 taken along line 10-10 of FIG. 1.

FIG. 2B is a sectional view of the piping element of FIG. 2A in accordance with another aspect of the current disclosure.

FIG. 3 is a sectional view of a nut of the fastener of FIG. 1 taken along line 10-10 of FIG. 1.

FIG. 4 is a sectional view of a gasket of the fastener of FIG. 1 taken along line 10-10 of FIG. 1.

FIG. 5 is an axial end view of a washer of the fastener of FIG. 1.

FIG. 6A is a sectional view of the washer of FIG. 5 taken along line 10-10 of FIG. 1.

FIG. 6B is a sectional view of the washer of FIG. 5 taken along line 10-10 of FIG. 1 in accordance with another aspect of the current disclosure.

FIG. 7 is a perspective view of a grip band of the fastener of FIG. 1.

FIG. 8 is an axial end view of the grip band of FIG. 7.

FIG. 9 is a sectional view of the grip band of FIG. 7 taken along line 10-10 of FIG. 1.

FIG. 10 is a sectional view of the joint assembly of FIG. 1 in an assembled condition taken along line 10-10 of FIG. 1 showing a pipe length defining a maximum or near-maximum diameter.

FIG. 11 is a sectional view of the joint assembly of FIG. 1 in an assembled condition taken along line 10-10 of FIG. 1 showing a pipe length defining a minimum or near minimum diameter.

FIG. 12 is a sectional view of a joint assembly similar to that shown in FIG. 1 in an assembled condition taken along line 10-10 of FIG. 1 showing a pipe length defining a minimum or near minimum diameter in accordance with another aspect of the current disclosure.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

The following description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B” as used herein means “only A, only B, or both A and B”; while the phrase “one of A and B” means “A or B.”

In one aspect, a joint assembly and associated methods, systems, devices, and various apparatuses are disclosed herein. In one aspect, the joint assembly can comprise a fastener and a piping element.

In the waterworks industry, pipe lengths formed from a variety of materials are buried and in service and will eventually need repair or replacement. It is often difficult to know what type of pipe fitting or joint assembly will seal and restrain a pipe length of unknown diameter that is discovered. Some pipe materials are no longer manufactured but still in service such as, for example and without limitation, polybutylene, and may need to be coupled to new pipe. For new construction within a nominal diameter such as ¾ inch, fittings are available for a variety of pipe materials, each having their own somewhat unique dimensions: copper tube (CTS), polyethylene pipe (PEP), polyvinylchloride (PVC) pipe, iron pipe, galvanized steel pipe, and brass pipe. As the label suggests, however, the nominal diameter is not the actual diameter of any of these pipes, and the actual diameter can fall within a range of sizes. Moreover, greater numbers of options can make selection of the correct parts more difficult. In contrast, selection of parts can be easier when a single fitting works on a range of pipe materials and diameters. A service truck can store a smaller parts inventory as well.

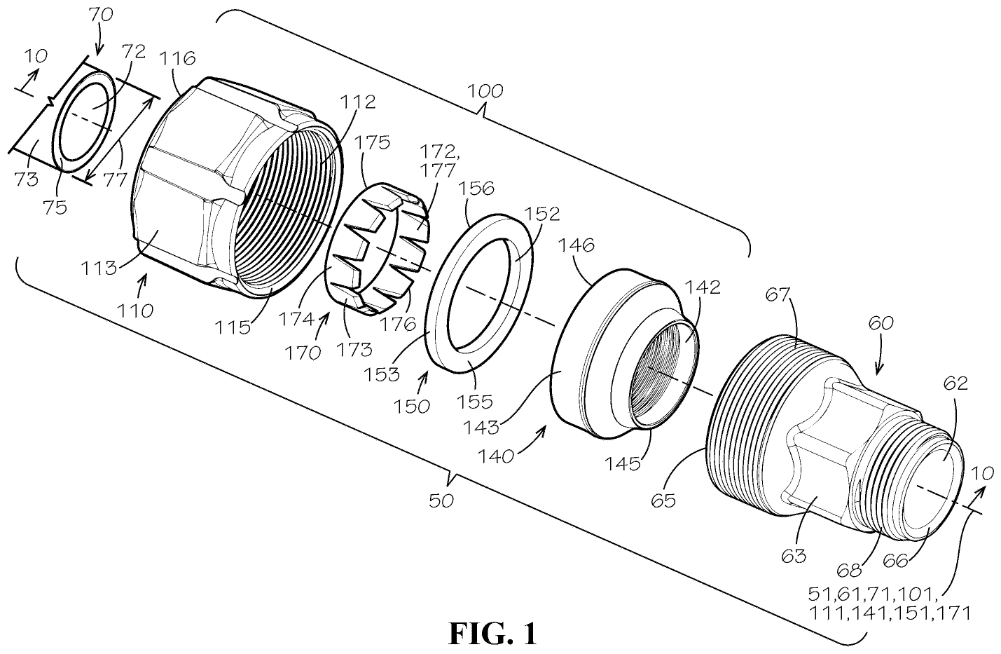

FIG. 1 is an exploded perspective view of a joint assembly 50. The joint assembly 50 can be a wide range fitting as shown and, as will be described in greater detail below, can accommodate a pipe length 70 defining any one of a range of values of an outer diameter 77. The joint assembly 50 can comprise a piping element 60, which can be joined to the pipe length 70. More specifically, the piping element 60 can be joined to the pipe length 70 with a fastener 100, which can be or can comprise a nut assembly. In some aspects, the piping element 60—and the joint assembly 50—can be any component of a fluid distribution system such as, for example, a valve, a fitting, an adapter, or a portion thereof. Each of the joint assembly 50, the piping element 60, the pipe length 70, and the fastener 100 can define respective axes 51,61,71,101, which can be coaxial in the present aspect.

In some aspects, the piping element 60—and the joint assembly 50—need not contain fluid and can be part of any sealed system including, for example and without limitation, an electrical power distribution system. More specifically, the joint assembly 50 and one or more pipe lengths 70 can form electrical conduit, in which case the joint assembly 50 can facilitate a fluid tight seal to keep any fluids—whether liquid or gas—out of the system. In contrast, benefits can arise from keeping the fluids in a fluid distribution system for storing and/or transporting fluids inside—and only inside—the components of the system.

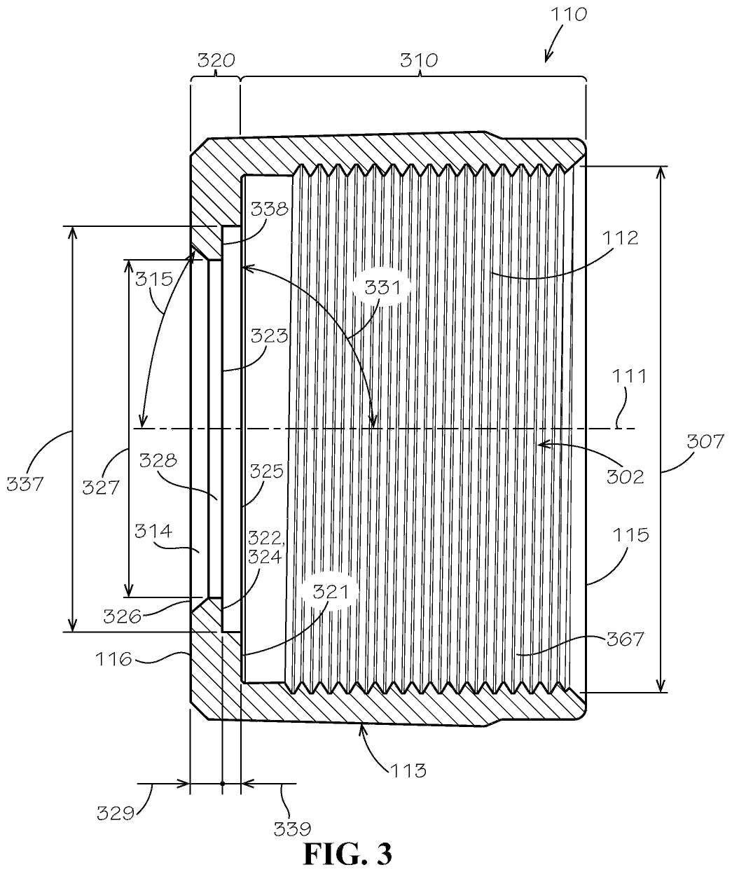

The piping element 60 can define an inner surface 62 and an outer surface 63, a first end 65 and a second end 66 distal from the first end 65. Each of the first end 65 and the second end 66 can define an opening. The piping element 60 can define a threaded portion 67 with which the fastener 100 and, more specifically, a nut 110 thereof can be engaged. The piping element 60 can define a threaded portion 68. In some aspects, as shown, either or both of the threaded portions 67,68 can define external threading. In some aspects, for example and without limitation, the threaded portion 68 of the piping element 60 can more specifically define compression nut threads and can couple the piping element 60 to a pipe length extending from the second end 66 of the piping element 60. In some aspects, the fastener 100 can facilitate one or more separate fastening elements (e.g., bolts defined separately from the nut 110 and the piping element 60), which can facilitate engagement of the nut 110 with the piping element 60 without the threaded portion 67 of the piping element 60 or a threaded portion 367 (shown in FIG. 3) of the nut 112 as shown. In some aspects, as suggested above, the piping element 60 can be a valve body, a male iron pipe, a female iron pipe, or some other type of adapter. In some aspects, as shown, the piping element 60 can have rotational symmetry about the axis 61. In some aspects, the piping element 60 can, at least in part, define a polygonal shape in axial cross-section, i.e., in a cross-section orthogonal with respect to the axis 61 of the piping element 60. The polygonal shape can be configured to receive a tool for rotation of the piping element 60 with respect to a mating part such as the nut 110 of the fastener 100. For example and without limitation, the piping element 60 can define a hexagonal shape in axial cross-section, which can be configured to receive a hex tool such as, for example and without limitation, a hex wrench or adjustable wrench with opposing flat and parallel tool surfaces. The nut 110 itself can define an axis 111, and other components of the fastener 100 such as, for example and without limitation, a gasket 140, a washer 150, and a grip band 170, can define respective axes 141,151,171. Any one or more of the axes 51,61,71,101,111,141,151,171 can be aligned with each other in an assembled condition of the joint assembly 50.

The pipe length 70, which can form a portion of any of the aforementioned systems together with the joint assembly 50, can define an inner surface 72, an outer surface 73, a first end 75, and a second end (not shown) distal from the first end 75. Each of the first end 75 and the second end can define an opening as well as a bore or inner cavity extending from the first end 75 to the second end. Either of the first end 75 and the second end can define a plain end of the pipe length 70. A plain end of the pipe length 70 is an end of the pipe length 70 that has not been further formed beyond cutting to length and optionally “breaking” or “dressing” the cut edges, e.g., with a chamfer. Therefore the plain end of the pipe length 70 in cross-section can be substantially the same size and shape as a cross-section of the pipe length 70 at a distance from the first end 75 or the second end. A plain end of a typical pipe as well as the cross-section of the pipe length 70 at a distance from the first end 75 or the second end can define the shape of a plain cylinder. The pipe length 70 can define an indeterminate length and follow any desired path and need not be straight and/or configured as shown.

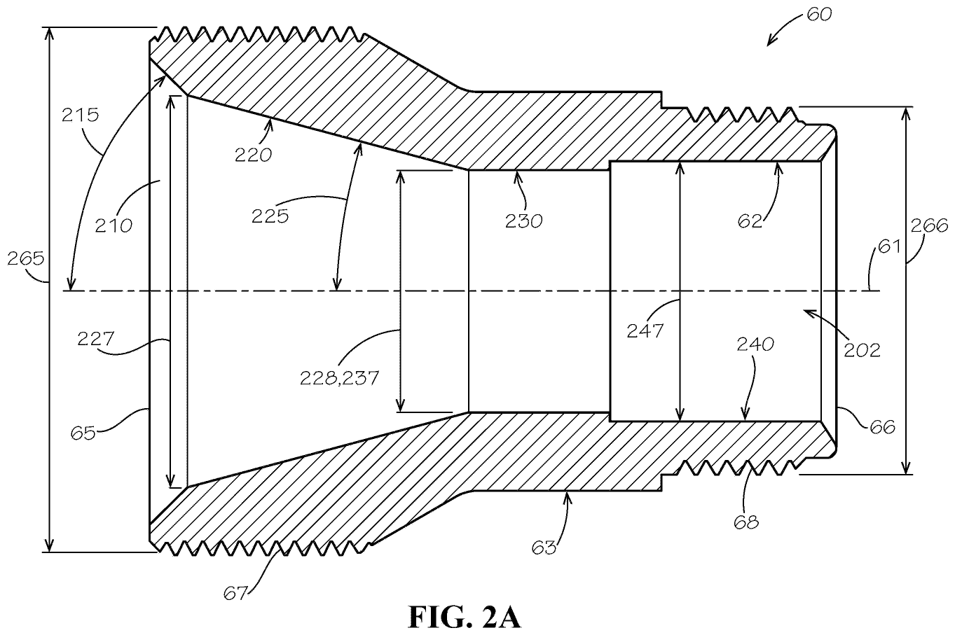

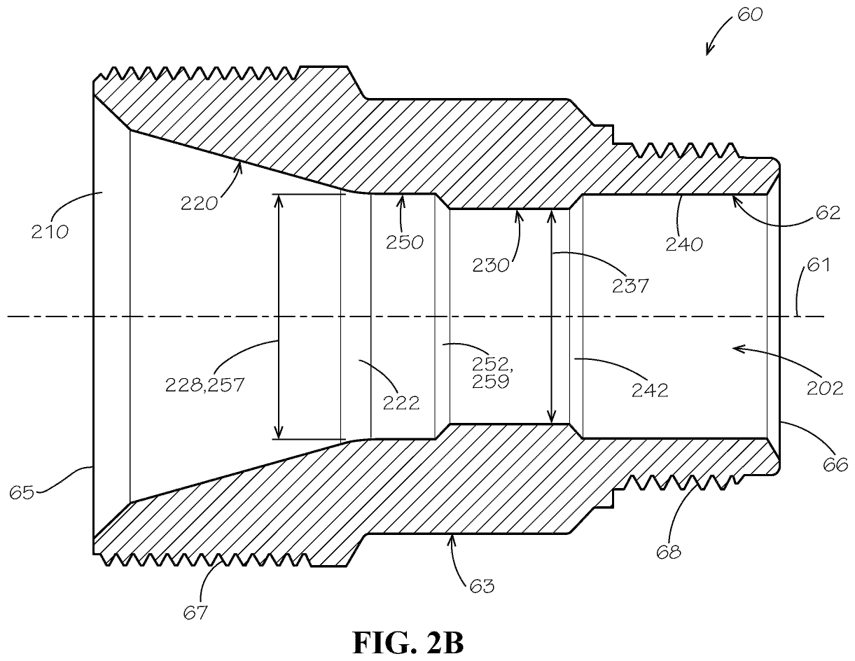

The fastener 100 can comprise the nut 110. The fastener 100 can comprise the gasket 140, which can be a seal or sealing member. The fastener 100 can comprise the washer 150. The fastener 100 can comprise the grip band 170 (shown in FIG. 2).

The nut 110 can define the inner surface 112, an outer surface 113, a first end 115, and a second end 116 distal from the first end 115. The nut 110 can, at least in part, define a polygonal shape in axial cross-section, i.e., in a cross-section orthogonal with respect to the axis 101 of the nut 110. The polygonal shape can be configured to receive a tool for rotation of the nut 110 with respect to the piping element 60. For example and without limitation, the nut 110 can define a hexagonal shape in axial cross-section, which can be configured to receive a hex tool such as, for example and without limitation, a hex wrench or adjustable wrench with opposing flat and parallel tool surfaces. As shown, the nut 110 can receive each of the piping element 60 and the pipe length 70.

The gasket 140 can define an inner surface 142, an outer surface 143, a first end 145, and a second end 146 distal from the first end 145. The gasket 140 can, at least in part and in axial cross-section, define an annular or ring shape and can be received within the nut 110 and received about or around the pipe length 70 in an assembled condition of the joint assembly 50. Simultaneously, the pipe length 70 can be received within the gasket 140 and the nut 110.

The washer 150 can define an inner surface 152, an outer surface 153, a first end 155, and a second end 156 distal from the first end 155. The washer 150 can, at least in part and in axial cross-section, define an annular or ring shape and can be received within the nut 110 and received about or around the pipe length 70. Simultaneously, the pipe length 70 can itself be received within the washer 150. In some aspects, the washer 150 can comprise a rigid material, which can mean that the material forming the washer 150 is non-compressible but not necessary inflexible. In some aspects, the washer 150 can comprise a material that is otherwise able to transfer a force from the grip band 170 to the gasket 140 during tightening of the joint assembly 50. In some aspects, the washer 150 can be a separate component. In some aspects, the washer 150 can be formed together with or be adhered or otherwise fastened to the gasket 140. As shown, a surface of the second end 146 of the gasket 140 and respective axial ends of the washer 150 and the grip band 170 can be orthogonal to the respective axes 141,151,171.

The grip band 170, which can be a grip ring, can comprise a body 174 and a plurality of teeth 177. The grip band 170 and, more specifically, each of the body 174 and the teeth 177 can define an inner surface 172, an outer surface 173, a first axial end 175, and a second axial end 176 distal from the first axial end 175. Each of the plurality of teeth 177 can extend from the first axial end 175 or from the body 174 and can be configured to contact the washer 150 and rotate with respect to the axis 171 of the grip band 170 about a hinge point of the corresponding tooth 177 and in transition between an uncompressed condition and a compressed condition of each of the grip band 170 and the joint assembly 50.

The gasket 140 can be positioned at least partially between the nut 110 and the piping element 60. The washer 150 can be positioned at least partially between the nut 110 and the gasket 140. The grip band 170 can be positioned at least partially between the nut 110 and the washer 150.

FIGS. 2A and 2B are sectional view of the piping element 60 of the joint assembly 50. FIG. 2 is a sectional view of the piping element 60 of the joint assembly 50 of FIG. 1 taken along line 10-10 of FIG. 1. The first end 65 can define an outer diameter 265 and the second end 66 can define an outer diameter 266. The outer diameters 265,266 can measure the same, or one of the outer diameters 265,265 can be greater than the other. As shown, the outer diameter 265 is greater than the outer diameter 266. As shown, each of the outer diameters 265,266 can be measured to a radially outermost portion of the respective threaded portions 67,68.

As shown, the piping element 60 and, more specifically, the inner surface 62 defining a bore or inner cavity 202, can define a first inner portion 210. Each of the first end 65 and the second end 66 can define an opening at each end of the inner cavity 202. The first inner portion 210 can be defined proximate to the first end 65 of the piping element 60. The piping element 60 can further define a second inner portion 220, which can extend from the first inner portion 210 and can be distal from the first end 65 of the piping element 60. The inner portions 210,220 can be a first conical inner portion and a second conical inner portion, respectively. The piping element 60 can define a slope angle 215 of the first conical inner portion 210 and a slope angle 225 of the second conical inner portion 220. The slope angles 215,225 of the first conical inner portion 210 and the second conical inner portion 220 can be measured with respect to the axis 61 of the piping element 60. As shown, the slope angle 225 of the second conical inner portion 220 can be less than the slope angle 215 of the first conical inner portion 210.

The second conical inner portion 220 can define a major diameter 227, which can be a minor diameter of the first conical inner portion 210. The conical portion 220 can define a minor diameter 228 and can define an inner diameter 237 of an inner portion 230 of the piping element 60. Meanwhile, the piping element 60 can define an inner portion 240 defining an inner diameter 247. The inner portions 230,240 can be cylindrical inner portions. The inner diameters 237,247 can measure the same, or one of the inner diameters 235,245 can be greater than the other. As shown, the inner diameter 247 is greater than the inner diameter 237. As shown, each of the inner diameters 237,247 can be measured to a radially innermost portion of the respective inner portions 230,240.

FIG. 2B is a sectional view of the piping element 60 of FIG. 2A in accordance with another aspect of the current disclosure. As shown, the inner surface 62 can define an inner portion 250, which can be a cylindrical inner portion. The inner portion 250 can define an inner diameter 257, which can be the minor diameter 228 of the second conical inner portion 220. The inner diameter 257 can be greater than the inner diameter 237 of the inner portion 230. As shown, transition portions 222, 242, and 252 can be or can define conical portions or radii. The transition portion 252, which can be defined between the inner portion 230 and the inner portion 250, can define a stop surface 259. The stop surface 259 can be angled with respect to the axis 61 of the piping element 60.

FIG. 3 is a sectional view of the nut 110 of the fastener 100 of FIG. 1 taken along line 10-10 of FIG. 1. The nut 110, which can define the inner surface 112, can define a bore or inner cavity 302 defining an inner diameter 307. Each of the first end 115 and the second end 116 can define an opening at each end of the inner cavity 302. The nut 110 and, more specifically, at least one of the inner surface 112 and the inner cavity 302 can define a first portion 310 proximate to the first end 115. The nut 110 can similarly define a second portion 320 proximate to the second end 116. The first portion 310 can be or can comprise or define the threaded portion 367. The second portion 320 can be or can comprise or define a flanged portion. As shown in FIG. 1, the outer surface 113 of the nut 110 can define portions, any of which can be flat or curved in axial cross-section and can at least substantially together define a polygonal shape or a circular shape in cross-section (where to “substantially” define a polygonal or circular shape means to define a polygonal or circular shape except where material has been added or removed to facilitate use of the nut 110, e.g., engagement and rotation of the nut 110 with a tool). In some aspects, as shown, the outer surface 113 can define on or more conical or cylindrical portions, which can be angled with respect to the axis 111 or each other.

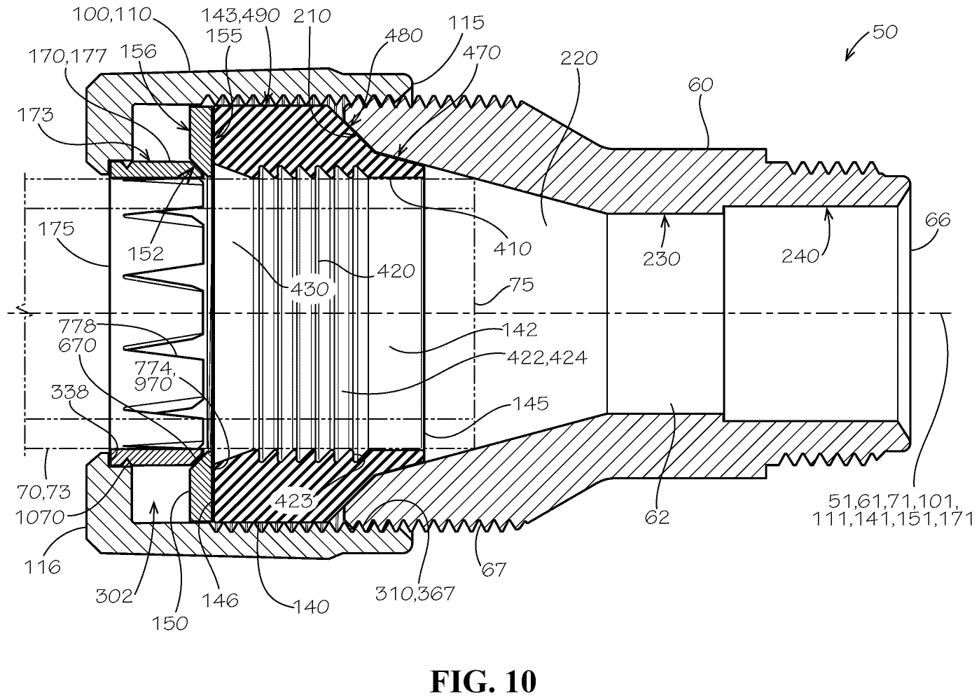

Referring back to FIG. 3, the second portion 320 of the nut 110 can define a step or shoulder 324 in an inner surface 322. The shoulder 324 can be sized to receive and position—even center—the grip band 170 (shown in FIG. 1) with respect to the axis 111 of the nut 110 such that the axis 171 (shown in FIG. 1) of the grip band 170 and the axis 111 of the nut 110 are aligned as shown in FIG. 10. The nut 110 and, more specifically, the second portion 320 can define a bore 328. The bore 328 can define a diameter 327, which can be sized to receive the pipe length 70 (shown in FIG. 1). The inner surface 322 and, more specifically, the shoulder 324 can define a notch or recess bore 338. The recess bore 338 can define a recess diameter 337, which can be sized to receive and even center the grip band 170 with respect to the axis 111. The bore 328 can define an axial length or height 329, and the recess bore 338 can define an axial length or height 339. Each of the heights 329,339 can be measured in an axial direction with respect to the axis 111. Portions of the nut 110 can, in radial cross-section, define angles with respect to the axis 111. For example and without limitation, an angled portion 321 of the inner surface 112 defined by the second portion 320 of the nut 110 can define an angle 331 that can be measured with respect to the axis 111. In some aspects, the angle 331 can measure 90 degrees. In some aspects, the angle 331 can measure a non-90-degree angle.

Either or each of a first end 325, a second end 326, and an intermediate edge 323 of the bore 328 and, more generally, the second portion 320 can define edge treatments. In some aspects, as shown, the first end 325 and the intermediate edge 323 can define a sharp edge. A “sharp edge” can be defined as a non-radiused and non-chamfered edge or the equivalent in which two surfaces, in cross-section, intersect without either first changing direction. The sharp edge of the first end 325, when present, can facilitate holding of the grip band 170 and even maximize a surface area of the shoulder 324. In some aspects, a sharp edge can define a slightly eased or “broken” edge to ensure the removal of burrs from the edge and to facilitate consistency in a geometric shape of the edge. More specifically, as shown, the second end 326 can define a chamfer 314. The chamfer 314 can define a chamfer angle 315. The chamfer 314 can facilitate insertion of the pipe length 70 into the bore 328 and through the nut 110 by providing a surface against which the first end 75 (shown in FIG. 1) of the pipe length 70 can be guided into the bore 328 when the axis 71 (shown in FIG. 1) of the pipe length 70 is not aligned with the axis 111 of the nut 110. In some aspects, any of the first end 325, the second end 326, the intermediate edge 323, or another edge of the nut 110 can define a radius. As shown, either or both of a first end 115 and a second end 116 of the nut 110 can define edge treatments on or intersecting with the outer surface 113. More specifically, as shown, the first end 115 can define a radiused edge, and the second end 116 can define a chamfer.

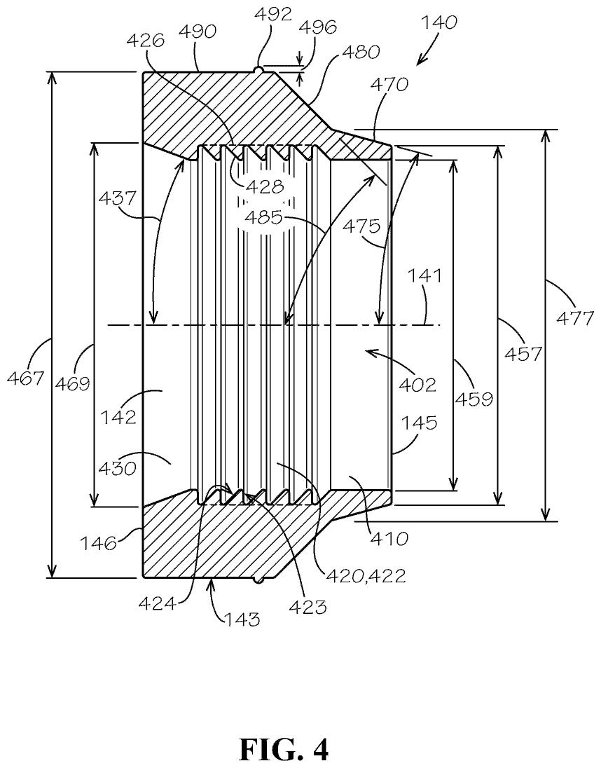

FIG. 4 is a sectional view of the gasket 140 of the fastener 100 of FIG. 1 taken along line 10-10 of FIG. 1. The first end 145 can define an outer diameter 457, and the second end 146 can define an outer diameter 467. As shown, the outer diameter 467 can be greater than the outer diameter 457. As shown, each of the outer diameters 457,467 can be measured to an axially outermost edge of the ends 145,146 or to an intersection of surfaces at the ends 145,146.

The first end 145 can define an inner diameter 459 and the second end 146 can define an inner diameter 469. The inner diameters 459,469 can measure the same, or one of the inner diameters 459,469 can be greater than the other. As shown, the inner diameter 469 can greater than the inner diameter 459. As shown, each of the inner diameters 459,469 can be measured to an axially outermost edge of the ends 145,146 or to an intersection of surfaces at the ends 145,146.

The gasket 140 and, more specifically, the inner surface 142 can define a bore or inner cavity 402. Each of the first end 145 and the second end 146 can define an opening at each end of the inner cavity 402. More specifically, the inner surface 142 can define one or more of a first inner portion 410, a second inner portion 420, and a third inner portion 430. The first inner portion 410, which can be defined proximate to the first end 145 of the gasket 140, can be or can comprise or define a cylindrical inner portion. The third inner portion 430, which can be defined proximate to the second end 146 of the gasket 140, can be or can comprise or define a conical inner portion defining an angle 437 relative to the axis 141. The second inner portion 420, which can be positioned between the first inner portion 410 and the second inner portion 420, can be or can comprise or define one or more ribs 422, which can be ridges or flanges.

Each of the ribs 422 can define a first side surface 423 and a second side surface 424. Each of the first side surface 423 and a second side surface 424 can be angled with respect to the axis 141. In some aspects, as shown, the first side surface 423 can be angled at 90 degrees with respect to the axis 141. In other aspects, the first side surface 423 can be angled at a non-90-degree with respect to the axis 141. In some aspects, as shown, the second side surface 424 can be angled at a non-90-degree angle with respect to the axis 141. In other aspects, the second side surface 424 can be angled at a 90-degree angle with respect to the axis 141. More specifically, each of the ribs 422 can, in extending into the inner cavity 402, define a triangular shape in cross-section when the gasket is in an uncompressed condition (with or without the “sides” of the triangular shape intersecting at sharp points). As shown, the second inner portion 420 can comprise a plurality of the ribs 422. More specifically, the second inner portion 420 can comprise at least five of the ribs 422. Each of the one or more of the first inner portion 410, the second inner portion 420, and the third inner portion 430 of the gasket 140 can be sized to receive and seal against the pipe length 70 (shown in FIG. 1) in one or both of an uncompressed condition and a compressed condition. More specifically, the third inner portion 430 can facilitate centering of the pipe length 70 during insertion of the pipe length 70 into the gasket 140. The one or more ribs 422 can facilitate an improved seal between the gasket 140 and the pipe length 70, which can result from increased compression forces between the gasket and the pipe at the ribs and can reduce leakage therebetween of a fluid stored or transported within the joint assembly 50 (shown in FIG. 1) or prevent entry of a fluid into a dry, empty, or gas-filled pipe length 70 such as an electrical conduit or into a system storing and/or transporting a different fluid therein. As shown, each of the ribs 422 and, more specifically, one or both of the first side surface 423 and the second side surface 424 can be, at least in part, sloped or angled towards the first end 145 of the gasket 140.

The gasket 140 and, more specifically, the outer surface 143 can define a first outer portion 470. The first outer portion 470 can be defined proximate to the first end 145 of the gasket 140. The gasket 140 and, more specifically, the outer surface 143 can further define a second outer portion 480, which can extend from the first outer portion 470 and distal from the first end 145 of the gasket 140. The outer portions 470,480 can be a first conical outer portion and a second conical outer portion, respectively. The gasket 140 can define a slope angle 475 of the first conical outer portion 470 and a slope angle 485 of the second conical outer portion 480. The slope angles 475,485 of the first conical outer portion 470 and the second conical outer portion 480 can be measured with respect to the axis 141 of the gasket 140. As shown, the slope angle 485 of the second conical outer portion 480 can be greater than the slope angle 475 of the first conical outer portion 470.

The first conical outer portion 470 can define a minor diameter 477, which can be a minor diameter of the second conical outer portion 480. The minor diameter 477 can measure between the outer diameter 457 and the outer diameter 467. A major diameter of the second conical outer portion 480 can equal the outer diameter 467. Meanwhile, the gasket 140 and, more specifically, the outer surface 143 can define an outer portion 490 defining the outer diameter 467. The outer portion 490 can be a cylindrical portion.

The outer surface 143 can define a rib 492, which can extend radially outward beyond a remaining portion of the gasket 140. More specifically, the rib 492 can extend by a rib height 496 from an outer portion of the gasket 140 such as, for example and without limitation, the third outer portion 490. In some aspects, as shown, the rib 492 can define a semicircular shape. In some aspects, the rib 492 can define a non-semicircular shape. In some aspects, the outer surface 143 can define a plurality of the ribs 492. The rib 492 can facilitate retention of the gasket 140 inside the nut 110 and, more specifically, the threaded portion 367, which can prevent any of the gasket 140, the washer 150, and the grip band 170 from falling out of the joint assembly 50 (shown in FIG. 1) before assembly and tightening of same.

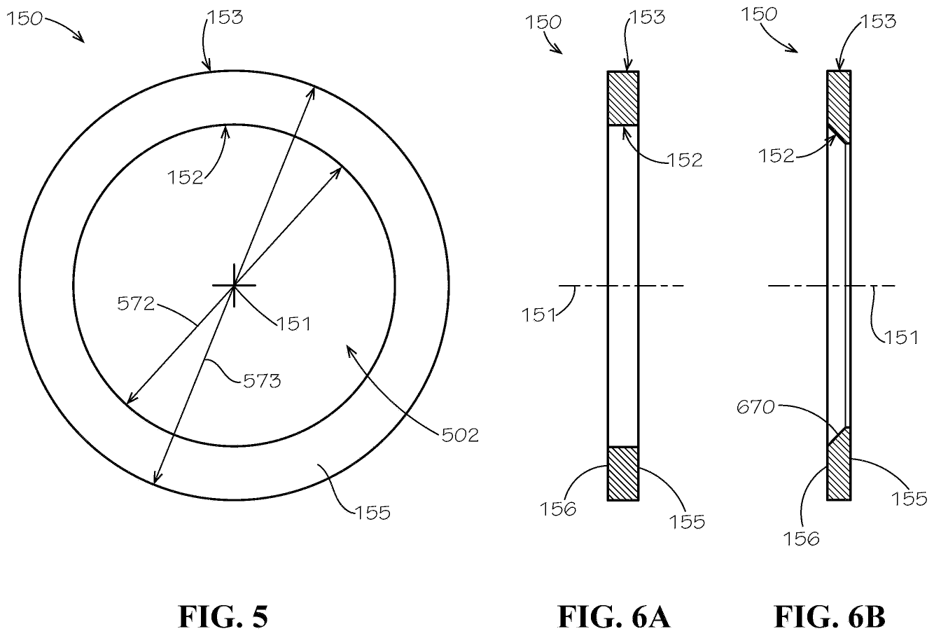

FIG. 5 is an axial end view of the washer 150 of the fastener 100 of FIG. 1. The washer 150, which can be formed separately from the gasket, can define an inner diameter 572 and an outer diameter 573. The washer 150 can further define a bore or inner cavity 502, and each of the first end 155 and the second end 156 (shown in FIG. 1) can define an opening at each end of the inner cavity 502. The inner diameter 572 can be sized to receive the pipe length 70 (shown in FIG. 1) in a range of sizes and, as will be described, can interact with the grip band 170 to facilitate tightening of the joint assembly 50 (shown in FIG. 1).

FIGS. 6A and 6B are sectional views of the washer 150 of FIG. 5. As shown in FIG. 6A, the inner surface 152 of the washer 150 can define a cylindrical portion. As shown in FIG. 6A, the inner surface 152 of the washer 150 or at least a portion thereof can define a conical portion. The conical portion of the inner surface 152 can be defined by a chamfer 670, and the inner surface 152 can further define a cylindrical portion intersecting the conical portion.

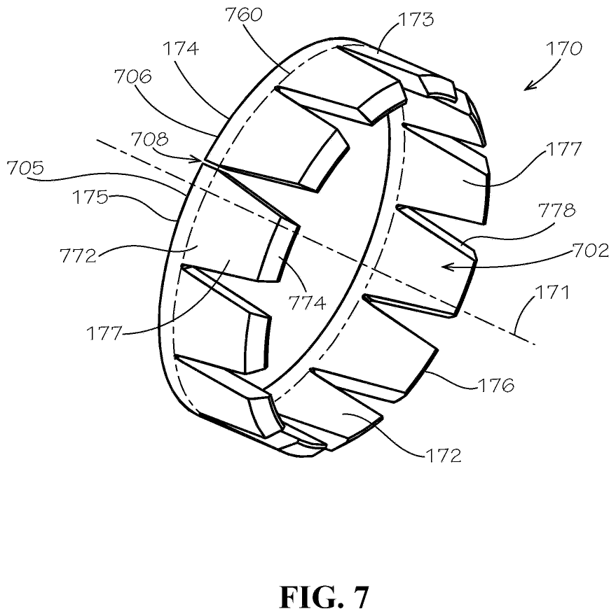

FIG. 7 is a perspective view of the grip band 170 of the fastener 100 of FIG. 1. The grip band 170 can define a bore or inner cavity 702, and each of the first end 175 and the second end 176 can define an opening at each end of the inner cavity 702. The body 174 can join adjacent teeth 177 of the plurality of teeth 177 to each other. The adjacent teeth of the plurality of teeth 177 can define a gap or notch 778 therebetween. More specifically, the notch 778 can be V-shaped. Each of the plurality of teeth 177 can define a base portion 772 and a tip or distal portion 774 and can taper from the base portion 772 towards the distal portion 774 in an axial direction of the grip band 170. As described above, the plurality of teeth 177 can extend from the first axial end 175 or, more specifically, from the body 174 of the grip band 170 and can be configured to contact the washer 150 and rotate about a hinge line 760 with respect to the axis 171 of the grip band 170 in transition between the uncompressed condition and the compressed condition of each of the grip band 170 and the joint assembly 50.

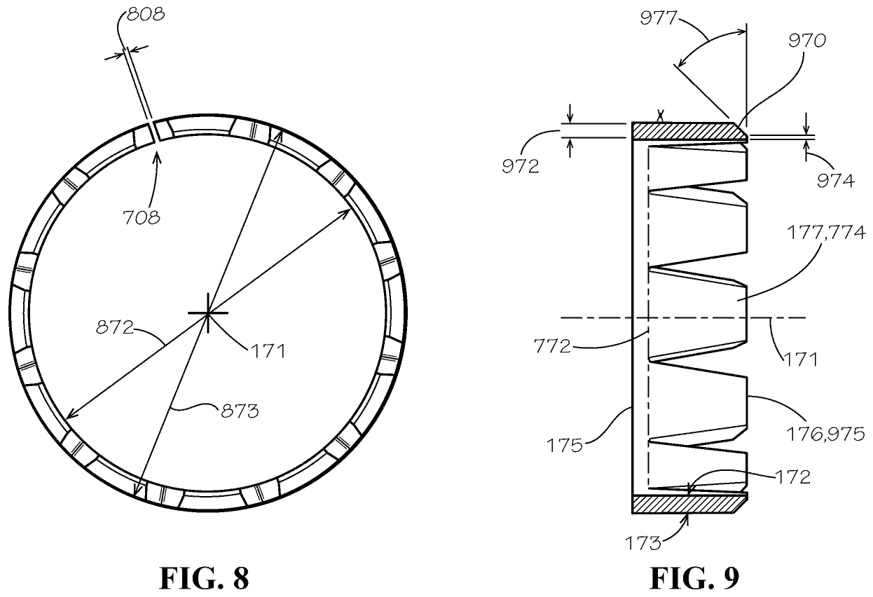

In some aspects, as shown, the grip band 170 can define a first circumferential end 705 and a second circumferential end 706, which can be joined together, i.e., at a joint not shown, or can define a gap 708 therebetween. In such aspects, the grip band 170 can be C-shaped. In some aspects, the grip band 170 can define a closed ring or annular shape without the aforementioned joint. The gap 708, which can define a gap width 808 (shown in FIG. 8), need not facilitate any compression of the grip band 170 in a radial direction with respect to the axis 171 at least because a diameter of the body 174 can remain constant while the teeth 177 rotate radially inward.

In some aspects, as noted above, the grip band 170 can comprise a rigid material, which can mean that the material forming the grip band 170 is non-compressible but not necessary inflexible. In some aspects, the grip band 170 can comprise a material that is otherwise able to transfer a force from the nut 110 to the gasket 140 (shown in FIG. 1) during tightening of the joint assembly 50. As shown, the grip band 170 can be asymmetrical about a vertical centerline angled at 90 degrees with respect to the axis 171 of the grip band 170.

FIG. 8 is an axial end view of the grip band 170 of FIG. 7. The grip band 170 can define an inner diameter 872 and an outer diameter 873. The inner diameter 872 can be sized to receive the pipe length 70 (shown in FIG. 1) in a range of sizes and, again, as will be described, can interact with the washer 150 to facilitate tightening of the joint assembly 50 (shown in FIG. 1). At least when the grip band 170 is in an uncompressed condition, each portion of the inner surface 172 of the grip band 170 can face radially inward and can define the inner diameter 872, which can be centered about the axis 141. As suggested above, the inner diameter 872 of at least a portion of the grip band 170 can be reduced by compression of the grip band 170 during assembly and tightening of the joint assembly 50.

FIG. 9 is a sectional view of the grip band 170 of FIG. 7. Each of the plurality of teeth 177 can define a tapered edge, in which case a thickness 972 of each of the plurality of teeth 177 at the distal portion 774 proximate to the second axial end 176 is less than the thickness 972 of each of the plurality of teeth 177 at the base portion 772 proximate to the second axial end 175. In some aspects, the tapered edge at the distal portion 774 of each of the plurality of teeth 177 can taper to a sharp edge defining an intersection between the outer surface 173 and the inner surface 172 of the grip band 170, in which case an edge height 974 can be zero. In some aspects, the tapered edge at the distal portion 774 of each of the plurality of teeth 177 can define an intersection between the outer surface 173 and an axial end surface 975 of the grip band 170, in which case the edge height 974 can be a positive dimension. In some aspects, the tapered edge of each of the plurality of teeth 177 can define a chamfer 970 in the corresponding tooth 177, the chamfer 970 facing radially outward when the grip band 170 is in an uncompressed condition. As shown, the chamfer 970 can define a chamfer angle 977, which can be measured with respect to a radial direction of the grip band 170 or with respect to the axial end surface 975 relative to the axis 171.

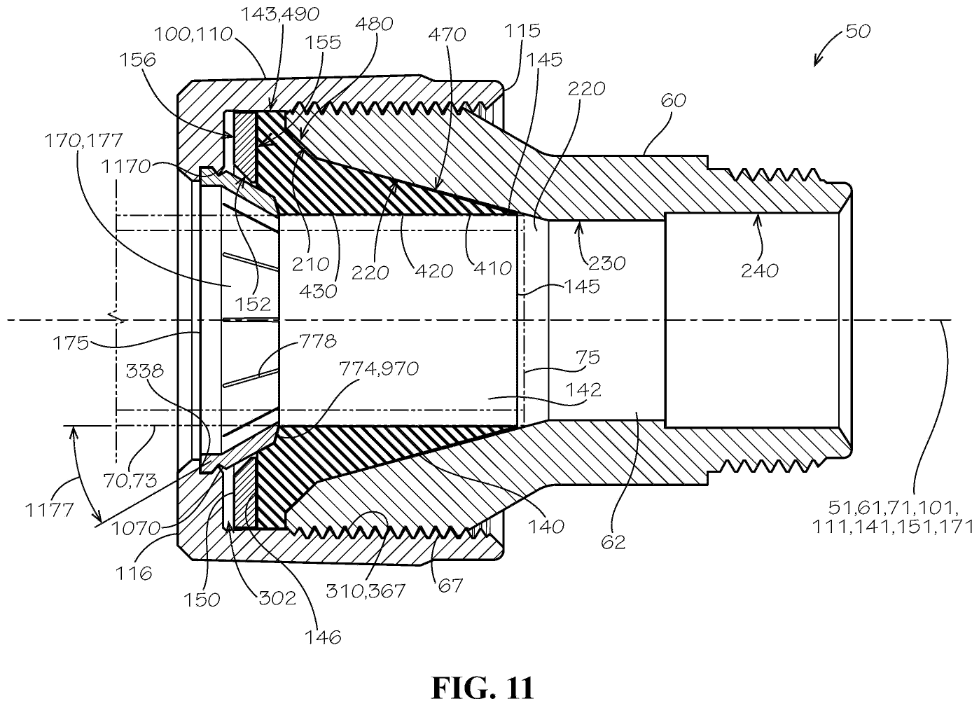

FIG. 10 is a sectional view of the joint assembly 50 of FIG. 1 in an assembled but untightened condition taken along line 10-10 of FIG. 1 showing the pipe length 70 (shown in transparency) defining a maximum or near-maximum diameter, and FIG. 11 is a sectional view of the joint assembly 50 in an assembled and tightened condition taken along line 10-10 of FIG. 1 showing the pipe length 70 (shown in transparency) defining a minimum or near-minimum diameter. More specifically, in some aspects, such as shown in FIG. 10 before tightening of the joint assembly 50 and compression of the gasket 140, a one-inch diameter copper tube (not shown) can be joined to the piping element 60; and, such as shown in FIG. 11 after tightening of the joint assembly 50 and compression of the gasket 140, a ¾-inch diameter copper tube (not shown) can be joined to the piping element 60. As such, the joint assembly 50 can be a ¾-inch CTS to one-inch CTS cross-diameter coupling. The pipe length 70 can be received within each of the fastener 100 and the piping element 60. Each of the fastener 100 and the piping element 60 can be configured to secure a position of the pipe length 70 with respect to each of the fastener 100 and the piping element 60.

As shown, the axis 71 of the pipe length 70 can be aligned with the axis 61 of the piping element 60 when the joint assembly 50 is tightened. More specifically, the first portion 210 and the second portion 220 of the piping element 60 can facilitate such centering of the pipe length 70 inside the piping element 60. For example and without limitation, the conical portions 210,220 or another self-centering portion of the inner surface 62 of the piping element 60 can naturally guide the pipe length 70 into such alignment when the joint assembly 50 is tightened. At least one way to facilitate such alignment includes angling the first end 75 of the pipe length 70 at 90 degrees with respect to the axis 71 of the pipe length 70.

The grip band 170 can be received within the nut 110 and received about or around the pipe length 70. More specifically, the grip band 170 can be positioned inside the inner cavity 302 of the nut 110. The gasket 140 can be positioned axially adjacent to the grip band 170 inside the inner cavity 302 of the nut 110, with an axial end surface of the second end 146 of the gasket 140 facing the grip band 170. The washer 150 can be positioned between—or, more specifically, axially between—the gasket 140 and the grip band 170. More specifically, at least one of an axial end surface of the first end 175 and the outer surface 173 of the grip band 170 can be in mating contact with and can be positioned within the recess bore 338 of the inner cavity 302 of the nut 110 in an assembled condition of the fastener 100.

In some aspects, as shown, the first end 145 of the gasket 140 can extend in an axial direction at least as far as the first end 115 of the nut 110. More specifically, the first end 145 of the gasket 140 can extend in an axial direction away from the second end 116 and past the first end 115 of the nut 110. In some aspects, a surface area of the gasket 140 in contact with the outer surface 73 of the pipe length 70 can be larger than previously seen. The enlarged surface area can facilitate an improved seal against the pipe length 70, including when long scratches on the pipe length 70 or other surface imperfections would otherwise not be covered by the gasket 140.

The pipe length 70 can be received within each of the piping element 60 and the fastener 100—and each portion thereof. More specifically, the inner surface 62 of the piping element 60 can face the outer surface 73 of the pipe length 70. As also shown, the piping element 60 be received within the fastener 100 and at least the nut 110 thereof. More specifically, an inner surface of respective components of the fastener 100 can face the outer surface 73 of the pipe length 70.

As shown, the first portion 310 and, more specifically, the threaded portion 367 of the nut 110 can engage the threaded portion 67 of the piping element 60, or the nut 110 can be otherwise configured to secure the pipe length 70 to the piping element 60 in an assembled and tightened condition by fixing a position of the nut 110 with respect to the piping element 60 and/or fixing a position of the pipe length 70 with respect to the nut 110 and the piping element 60.

In a loosened condition of the joint assembly 50 shown, the first end 145 of the gasket 140 can face and, more specifically, can contact the inner surface 62 of the piping element 60. In some aspects, as shown, at least a portion the inner surface 62 can slope or be oblique with respect to a radial direction of the gasket 140. More specifically, the inner surface 62 can define the aforementioned conical portions 210,220. In some aspects, end surfaces of the first end 145 and the second end 146 of the gasket 140 can measure 90 degrees with respect to the axis 141, i.e., the end surfaces of the respective ends 145,146 can be orthogonal to the axis 141.

One or more features of the washer 150 and the grip band 170 can work together to facilitate compression of at least a portion of the grip band 170 in a radial direction towards and, in some aspects, into the pipe length 70. Upon contact with the pipe length 70, a surface of each tooth 177 such as the inner surface 172 (shown in FIG. 1) at the tooth 177 can be said to have a non-90-degree angle of attack 1177 (shown in FIG. 11) with respect to the outer surface 73 of the pipe length 70. More specifically, the angle of attack 1177 can be an acute angle. In some aspects, the angle of attack 1177 can measure at least 45 degrees and less than 90 degrees.

In some aspects, as shown, the distal portion 774 of each of the plurality of teeth 177 and, more specifically, the chamfer 970 that can be defined therein can contact the washer 150 upon tightening of the joint assembly 50. More specifically, the distal portion 774 and, in some aspects, the chamfer 970 can contact the inner surface 152 of the washer 150. In some aspects, the distal portion 774 can contact an end surface defined by the second end 156 of the washer 150 or an edge defined by an intersection between such an end surface and the inner surface 152 of the washer 150. In some aspects, such as when either the teeth 177 of the grip band 170 or the inner surface 152 of the washer 150 do not define a chamfer or when neither the teeth 177 nor the inner surface 152 define a chamfer, relative sizing of the grip band 170 and the washer 150 and interaction between the grip band 170 and the washer 150 can still result in compression of the grip band 170 upon tightening of the joint assembly 50. More specifically, the distal portion 774 of each of the teeth 177 can define a blunt second end 176 of the grip band 170. In some aspects, for example, a chamfer on just one of the grip band 170 and the washer 150 will push or “bias” the distal end 774 of each of the plurality of teeth 177 radially inward and thereby result in rotation of the teeth 177 towards the pipe length 70. For example, the chamfer 670 of the washer 150 can direct or push the teeth 177 of the grip band 170 radially inward. In some aspects, a slight pre-bending of the teeth 177 towards the axis 171 can result in rotation of the teeth 177 towards the pipe length 70 upon such tightening even when no chamfer is present on either of the grip band 170 and the washer 150. In some aspects, the gasket 140 can direct or push the teeth 177 of the grip band 170 radially inward. In addition to each of the individual teeth 177 of the grip band 170 rotating about a corresponding hinge point, the grip band 170 can itself initially rotate about the axis 101 with respect to other components of the joint assembly 50 upon tightening thereof, particularly before engagement of the teeth 177 with the pipe length 70.

Upon tightening of the joint assembly 50 and, more specifically, tightening of the nut 110 against the piping element 60, the gasket 140 can be compressed and pushed in any radial or axial direction to seal between the gasket and any one or more of the piping element 60, the pipe length 70, the nut 110, and the washer 150. More specifically, any or all of the first outer portion 470, the second outer portion 480, and the third outer portion 490 of the gasket 140—and, in some aspects, and end surface of the first end 145—can contact and seal against the inner surface 62 and, more specifically, the respective portions 220,210 of the piping element 60. Likewise, any or all of the first inner portion 410, the second inner portion 420, and the third inner portion 430 of the gasket 140 can contact and seal against the pipe length 70 and, more specifically, the outer surface 73 of the pipe length 70. Likewise, any of the outer surface 143 of the gasket 140 can contact and seal against the nut 110 and, more specifically, the inner surface 112 of the nut 110. Likewise, an end surface of the second end 146 of the gasket 140 can contact and seal against the washer 150 and, more specifically, an end surface of the first end 155 of the washer 150. Upon tightening of the joint assembly 50, the ribs 422 defined in the inner surface 142 of the gasket 140 can themselves compress and change shape and in the process, as described above, can result in an improved seal where the ribs 422 are in contact with the pipe length 70.

In FIG. 11, a slight simplification of the structure of the gasket 140 is shown. More specifically, each of the ribs 422 (shown in FIG. 10) may not completely flatten and disappear as shown. Even if each of the ribs 422 is significantly deformed upon tightening of the joint assembly 50, a gasket sealing pressure will generally not be constant across the inner surface 142 of the gasket 140 when the ribs 422 are present and will instead be higher at the ribs 422 and lower between the ribs 422. When each of the ribs 422 and, more specifically, one or both of the first side surface 423 (shown in FIG. 10) and the second side surface 424 (shown in FIG. 10) is, at least in part, sloped or angled towards the first end 145 of the gasket 140, a force required to pull the pipe length 70 away from the piping element 60 and out of the joint assembly 50 can be further increased. The third portion 430, including when defining a conical inner portion defining the angle 437 (shown in FIG. 4), can facilitate insertion of the pipe length 70 therein, as noted above.

As shown in each of FIGS. 10 and 11, the minimum inner diameter of the piping element 60 (e.g., either or both of the diameters 228, 237 shown in FIG. 2) can be less than the outer diameter 77 (shown in FIG. 1) of the pipe length 70 in the joint assembly 50. When the minimum inner diameter of the piping element 60 is less than the outer diameter 77 (shown in FIG. 1) of the pipe length 70, the first end 75 of the pipe length 70 can contact and be restrained by the inner surface 62 of the piping element 60 instead of passing through the piping element 60 and beyond the second end 66 thereof. More specifically, the first end 75 of the pipe length 70 can contact and be restrained by at least one of the first portion 210 and the second portion 220 of the piping element 60, which can be the aforementioned first and second conical portions, respectively. When in contact with and restrained by the piping element 60, the pipe length 70 can be prevented from sliding further through or otherwise moving with respect to the piping element 60 upon tightening of the fastener 100 against the piping element 60. This condition, i.e., of a position of the pipe length 70 being fixed relative to the piping element 60, can facilitate engagement between the fastener 100 and the pipe length 70 and, more specifically, between the pipe length 70 and either or both of the grip band 170 and the gasket 140. Whether or not the pipe length 70 will, in each installation, contact the piping element 60 before full engagement of the joint assembly 50, such engagement can comprise the gasket 140 and the grip band 170 more fully engaging with a particular portion of the stationary pipe length 70. While the forces exerted by either or both of the gasket 140 and the grip band 170 on the pipe length 70 may initially cause movement of the pipe length 70 in an axial direction with respect to at least the piping element 60, upon contact with the piping element 60 further movement of the pipe length 70 can be limited or prevented and either or both of the gasket 140 and the grip band 170 can be driven further into the outer surface 63 of the pipe length 70 upon the tightening of the fastener 100. In some aspects, it can be beneficial for the first end 75 of the pipe length 70 to contact the piping element 60 before the gasket 140 squeezes into any gap remaining between the first end 75 of the pipe length 70 and the piping element 60.

A tensile strength or pull-out strength of the resulting joint can be so strong that the material of the pipe length 70, e.g., copper forming a hollow tube of the pipe length 70, can weaken and fail prior to failure of the joint assembly 50 by pulling of the pipe length 70 from the piping element 60. In other words, a strength or resistance of the joint assembly 50 against pull-out of the pipe length 70 from the joint assembly 50 can be at least as great, if not greater, than a tensile strength of the pipe length 70, even when the joint assembly 50 is tightened with a lower torque than is typically used. The strength can and will generally vary based on at least the size of the joint assembly 50 and the outer diameter 77 (shown in FIG. 1) and a wall thickness of the pipe length 70.

The biasing of the plurality of teeth 177 of the grip band 170 towards and into engagement with the pipe length 70 by interaction between at least the washer 150 and the grip band 170 can require less force, which can result in a lower installation torque being required. More specifically, the structure of the disclosed grip band 170 itself can facilitate engagement of the grip band 170 with the pipe length 70. For example and without limitation, the teeth 177 can bend about the hinge line 760 and can be separated by or with the notches 778. In some aspects, the notches 778 can be triangular as shown. In some aspects, as shown in FIG. 11, the notches 778 are “closed” at full engagement by the movement of the teeth 177 towards each other and, in some aspects, contact with each other. Such closure of the notches 778 can block extrusion of the gasket 140 through gaps that would otherwise exist, and such gaps can reduce a sealing pressure between the gasket 140 and the pipe length 70. In any case, the lower installation torque requirements can reduce the risk of failure compared to a fitting requiring higher torque, which is in practice not always applied—and in some cases cannot be applied under actual field conditions.

In some aspects, as shown in FIGS. 10 and 11, the grip band 170 can define a groove 1070, which can facilitate and further ease, at an even lower tightening torque, bending of the plurality of teeth 177 and engagement of same with the pipe length 70. The groove 1070 can ensure that the weakest point or line is a desired hinge point or line for the teeth 177. In some aspects, as shown, the groove 1070 can be V-shaped in cross-section. In other aspects, the groove 1070 can be semicircular or otherwise rounded in cross-section. As shown in FIG. 11, the nut 110 can define a ridge or flange 1170, which can extend radially inward and into the groove 1070 of the grip band 170 to facilitate retention of the grip band 170 by the nut 110. To facilitate installation of the grip band 170, including when the flange 1170 is present, the gap 708 (shown in FIG. 7) can be adjusted to allow sufficient compression of the grip band 170 during installation.

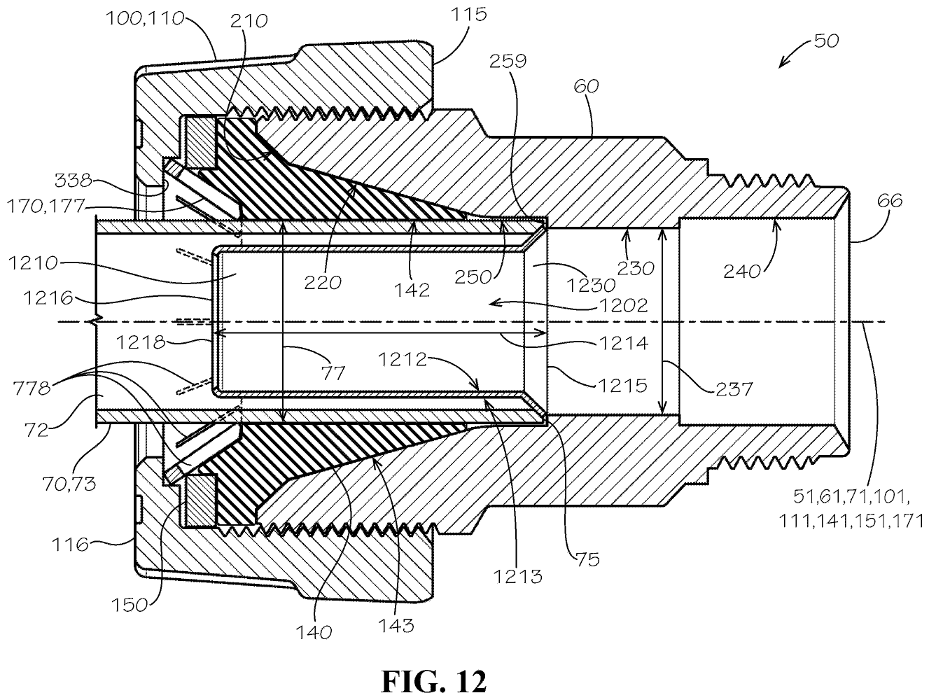

FIG. 12 is a sectional view of the joint assembly 50 similar to that shown in FIG. 1 in an assembled condition taken along line 10-10 of FIG. 1 showing the pipe length 70 defining a minimum or near minimum diameter in accordance with another aspect of the current disclosure. At least a portion of the first end 75 of the pipe length 70 can be received within the inner portion 250. At least a portion of the outer surface 73 can face and can be parallel to the inner portion 250. The first end 75 of the pipe length 70 can contact the stop surface 259, and the stop surface 259 can limit movement of the pipe length 70 in an axial direction into (i.e., can prevent “overstabbing” of the pipe length 70 into) the piping element 60. Again, the outer diameter 77 of the pipe length 70 can be greater than the diameter 237 of the inner portion 230. As shown, a rigid pipe insert stiffener 1210 can help maintain—or limit compression of—the outer diameter 77 when the grip band 170 presses into the pipe length 70, especially when the pipe length 70 is formed from a softer material such as polyethylene. Because the pipe insert stiffener 1210 can have a predetermined length 1214, the stop surface 259 can prevent a softer pipe from being inserted or “stabbed in” so far that the grip band 170 engages a portion of the pipe length 70 that is unsupported by the pipe insert stiffener 1210. In contrast, as shown, without special care an installer can ensure that the grip band 170 engages a portion of the pipe length 70 where supported by the pipe insert stiffener 1210. As shown, the pipe insert stiffener 1210 can define a first end 1215, which can be proximate to and even aligned axially with the first end 75 of the pipe length 70, a second end 1216 distal from the first end 1215, an inner surface 1212, an outer surface 1213 facing the inner surface 72 of the pipe length 70, a bore 1202, an opening 1218, and a flange 1230, which can itself contact the stop surface 259. In some aspects, the flange 1230 can define a conical shape, which can flare outward in a radial direction, in an axial direction, or in both radial and axial directions as shown and, more specifically, can define at least one of a conical inner surface and a conical outer surface. As shown, the flange 1230 and, more specifically, an axial end thereof can contact the first end 75 of the pipe length 70 to limit movement of the pipe insert stiffener 1210 in an axial direction into the pipe length 70.

The components of the joint assembly 50 and, more specifically, the fastener 100 and any portion thereof can be formed from any one of a variety of materials selected based on their strength characteristics, weight, and cost. In some aspects, it will be beneficial to select a material with sufficient strength to avoid deformation, corrosion, or fatigue in use.

At least the piping element 60, the pipe length 70, the nut 110, the washer 150, and the grip band 170 can be formed from or comprise a rigid material such as, for example and without limitation, metal. In other aspects, another material can be used for any parts formed from or comprising a rigid material such as, for example and without limitation, a metal other than stainless steel, a composite material, or a polymer resin—including of the fiber-reinforced kind.

In some aspects, the grip band 170 can be formed from stainless steel or, more specifically, a material such as, for example and without limitation, 301 spring-tempered stainless steel or the equivalent. Components that generally deform such as the grip band 170 (shown in FIG. 4) can be configured and selected to deform in at least one orientation, in which case a material with appropriate characteristics can be used. In some aspects, to facilitate secure engagement of the fastener 100 and, more specifically, the grip band 170 with the pipe length 70, a material can be chosen for the grip band 170 that is harder than the material from which the pipe length 70 is formed. In some aspects, a material can be chosen for the grip band 170 that is harder than any of the materials from which the pipe length 70 could be formed.

In other aspects, a flexible and compressible material can be used for the parts configured to deform such as, for example and without limitation, rubber, an elastomer. The gasket 140 can be formed from a flexible, resilient material such as a natural or synthetic rubber such as, for example and without limitation, ethylene propylene diene monomer (EPDM) rubber or nitrile rubber, which is also known as Buna-N.

The pipe length 70 can be formed from any suitable and available material such as, for example and without limitation, copper (soft or hard); polyethylene (PE) or, more specifically, high-density polyethylene (HDPE) and/or cross-linked polyethylene (PEX); polyvinylchloride (PVC) or, more specifically, chlorinated polyvinylchloride (CPVC); polypropylene (PP); steel; or brass. When using a softer material for the pipe length 70, use of the aforementioned pipe insert stiffener 1210 can help maintain or limit radial compression of an inner diameter of the pipe length 70 and thereby also the outer diameter 77 of the pipe length 70 during tightening of the joint assembly 50.

In some aspects, the joint assembly 50 or portions thereof can be formed from traditional material forming processes such as casting, extruding, and machining. In some aspects, the structure can be formed from a powder in a 3D printing or other additive manufacturing process, from pellets in a molding process, or from another raw material form and forming process.

A method of using the joint assembly 50 can comprise engaging the fastener 100 with the piping element 60. The method of engaging the fastener 100 with the piping element 60 can comprise engaging with the pipe length 70 with an edge of each of the plurality of teeth 177 of the grip band 170. The method can comprise inserting the pipe length 70 through the fastener 100 and into the piping element 60. The method can comprise tightening the fastener 100 against the piping element 60. Tightening the fastener 100 against the piping element 60 can itself comprise reducing the inner diameter 872 of the grip band 170 while maintaining the outer diameter 873 of the grip band 170; and engaging the grip band 170 with the pipe length 70 to fix or secure a position of the pipe length 70 with respect to a position of each of the fastener 100 and the piping element 60.

The method of tightening the fastener against the piping element 60 can comprise compressing the ribs 422 of the gasket 140 of the fastener 100. The method of compressing the ribs 422 of the gasket 140 can comprise applying a gasket sealing pressure at each of the ribs 422 that is higher than a gasket sealing pressure between the ribs 422. The method of engaging the grip band 170 with the pipe length 70 can comprise engaging with the pipe length 70 a sharp edge of the tapered edge of each of the plurality of teeth 177 of the grip band 170. Engaging the grip band 170 with the pipe length 70 can comprise contacting the washer 150 with the plurality of teeth 177 of the grip band 170; and rotating the plurality of teeth 177 of the grip band 170 with respect to the axis 171 of the grip band 170 in transition between the uncompressed condition and a compressed condition. The method of tightening the fastener 100 against the piping element can comprise contacting the first conical portion 210 with the gasket 140. The method of tightening the fastener 100 against the piping element 60 can comprise aligning the axis of the pipe length 70 with the axis 61 of the piping element 60.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A joint assembly comprising:
a piping element; and
a fastener configured to secure a pipe length to the piping element, the fastener comprising:
a nut;
a gasket positioned at least partially between the nut and the piping element; and
a grip band positioned at least partially between the nut and the gasket, the grip band defining a first axial end and a second axial end, the grip band comprising a plurality of teeth extending from the first axial end, each of the plurality of teeth configured to rotate with respect to an axis of the grip band in transition between an uncompressed condition and a compressed condition to change a corresponding angle of attack of each of the plurality of teeth with respect to the pipe length.

2. The joint assembly of claim 1, wherein the piping element defines a first conical portion proximate to a first end of the piping element.

3. The joint assembly of claim 2, wherein the piping element further defines a second conical portion extending from the first conical portion and distal from the first end of the piping element, a slope angle of the second conical portion being less than a slope angle of the first conical portion, each of the slope angle of the first conical portion and the slope angle of the second conical portion measured with respect to an axis of the piping element.

4. The joint assembly of claim 1, further comprising a washer positioned at least partially between the nut and the gasket.

5. The joint assembly of claim 4, wherein an inner surface of the washer defines a conical shape.

6. The joint assembly of claim 4, wherein the washer is formed together with the gasket.

7. The joint assembly of claim 1, wherein the nut defines a shoulder in an inner surface, the shoulder sized to receive and position the grip band with respect to an axis of the nut.

8. The joint assembly of claim 1, wherein each of the plurality of teeth defines a tapered edge at the second axial end of the grip band.

9. The joint assembly of claim 8, wherein the tapered edge of each of the plurality of teeth defines a chamfer in the corresponding tooth, the chamfer facing radially outward when the grip band is in the uncompressed condition.

10. The joint assembly of claim 1, wherein adjacent teeth of each of the plurality of teeth define a notch therebetween.

11. The joint assembly of claim 1, further comprising the pipe length, the pipe length received within each of the fastener and the piping element, each of the fastener and the piping element configured to secure a position of the pipe length with respect to each of the fastener and the piping element.

12. The joint assembly of claim 11, wherein a minimum inner diameter of the piping element is less than an outer diameter of the pipe length.

13. The joint assembly of claim 11, wherein an axis of the pipe length is aligned with an axis of the piping element when the joint assembly is tightened.

14. A method of using a joint assembly, the method comprising:
engaging a fastener with a piping element, the fastener comprising:
a nut;
a gasket positioned at least partially between the nut and the piping element; and
a grip band positioned at least partially between the nut and the gasket, the grip band comprising a plurality of teeth;
inserting a pipe length through the fastener and into the piping element; and
tightening the fastener against the piping element, which comprises:
reducing an inner diameter of the grip band while maintaining an outer diameter of the grip band; and
engaging the grip band with the pipe length to fix a position of the pipe length with respect to a position of each of the fastener and the piping element.

15. The method of claim 14, wherein tightening the fastener against the piping element comprises compressing ribs of the gasket of the fastener.

16. The method of claim 14, wherein pairs of adjacent teeth of the plurality of teeth of the grip band define notches therebetween, the method further comprising closing the notches by movement of the adjacent teeth towards each other to block extrusion of the gasket through the notches.

17. The method of claim 14, wherein engaging the grip band with the pipe length comprises engaging with the pipe length a sharp edge of a tapered edge of each of the plurality of teeth of the grip band.

18. The method of claim 14, wherein the fastener further comprises a washer positioned at least partially between the nut and the gasket, and wherein engaging the grip band with the pipe length comprises:
contacting the washer with the plurality of teeth of the grip band; and
rotating the plurality of teeth of the grip band with respect to an axis of the grip band in transition between an uncompressed condition and a compressed condition.

19. The method of claim 14, wherein the piping element defines a conical portion proximate to a first end of the piping element, and wherein tightening the fastener against the piping element comprises contacting the conical portion with the gasket.

20. The method of claim 14, wherein the piping element defines a conical portion proximate to a first end of the piping element, and wherein tightening the fastener against the piping element comprises aligning an axis of the pipe length with an axis of the piping element.
